(19) United States
(12) Patent Application Publication
(10) Pub. No.: US 2018/0145328 A1
(43) Pub. Date: May 24, 2018

(54) GRAPHENE OXIDE-POLYMER AEROGELS AND ELECTRODES

(71) Applicant: Board of Regents, The University of Texas System, Austin, TX (US)

(72) Inventors: Charles Buddie Mullins, Austin, TX (US); Christopher J. Ellison, Eden Prairie, MN (US); Heonjoo Ha, Falcon Heights, MN (US); Kyle C. Klavetter, Albuquerque, NM (US); J. Pedro de Souza, Cambridge, MA (US)

(21) Appl. No.: 15/876,863

(22) Filed: Jan. 22, 2018

Related U.S. Application Data
(63) Continuation of application No. PCT/US2016/045828, filed on Aug. 5, 2016.
(60) Provisional application No. 62/202,659, filed on Aug. 7, 2015.

(51) Int. Cl. H01M 4/583; H01M 10/0525; H01M 4/525; H01M 4/58; C08L 33/02; C08K 3/04; H01M 4/62

(52) U.S. Cl. CPC H01M 4/583; H01M 10/0525; H01M 4/525; H01M 4/5825; C08L 33/02; C08F 2810/20; H01M 4/625; H01M 4/622; C08L 2203/20; C08J 2205/026; C08K 3/042

(57) ABSTRACT

The present disclosure relates to an electrode including an active material and a reduced graphene oxide-polymer aerogel. The present disclosure further relates to electrochemical devices, such as batteries, fuel cells, electrochemical sensors, and pseudocapacitance ultracapacitors containing such electrodes. The disclosure further relates to methods of forming and using the aerogels, electrodes, and electrochemical devices.

### PRIORITY CLAIM

The present application claims priority to U.S. Provisional Patent Application Ser. No. 62/202,659, tilted “Graphene Oxide-Polymer Aerogels and Electrodes,” filed August 7, 2015, which is incorporated by reference herein.

### TECHNICAL FIELD

The present disclosure relates to electrodes, particularly to electrodes formed from an active material on a novel porous scaffold. The disclosure also relates to electrochemical devices containing the electrodes.

### BACKGROUND

Electrochemical devices function by exchanging energy between an external electrical circuit and a chemical. For instance, during use, a battery produces electrical current, which is simply free electrons moving through a conductor, such as a metal wire, by removing those electrons from a chemical in the battery. This electron removal occurs in a part of the battery referred to as an electrode.

If the battery is rechargeable the chemical, often referred to as an active material, can both lose and gain electrons depending on whether the battery is supplying a current or being charged by an outside current supplied to the battery. Inside the battery the active material also loses and gains charged elements or compounds, called ions, to compensate for the loss or gain of electrons. Typically the active material that loses an electron and an ion when the battery supplies current and is discharged is called the anode active material and the electrode where it is located is called the anode. At the same time the anode loses an electron and an ion, the other electrode in the battery, called the cathode, gains an electron and ion in the cathode active material.

If the battery is rechargeable, the process merely happens in reverse when a current is supplied to the battery to charge it; the cathode active material in the cathode loses an electron and an ion, while the anode active material, at the same time, gains an electron and an ion.

During both discharge and charge, the ions move within the battery through a material called the electrolyte that also contains the type of ions entering and leaving the cathode active material and anode active material. Typically, if the battery is rechargeable, it is named after the electrolyte ion, called the working ion, such as the lithium ion (Li⁺) in lithium ion batteries and the sodium ion (Na⁺) in sodium ion batteries.

If a battery is not rechargeable, then the electron and ion movement process can occur one time only and once the anode active material has lost an electron and an ion, or once the cathode active material has gained an electron and an ion, they cannot gain or lose them again, respectively.

Other electrochemical devices also contain active materials in one or more electrodes. For instance, fuel cells often contain a catalyst anode active material that forms an ion, such as hydrogen ion (H⁺), that travels to the cathode through an electrolyte, and an electron that travels through an external circuit, providing electrical energy, before it recombines with the H⁺ at the cathode. Although most fuel cells only have an active material at the anode, a fuel cell cathode may also contain an active material to catalyze the recombination.

Other electrochemical devices with active materials in one or more electrodes, including, in some devices, a reference electrode, include a variety of electrochemical sensors, such as gas detectors or medical sensors.

Still other such devices include ultracapacitors (also called supercapacitors) that exhibit pseudocapacitance via a reduction/oxidation (redox) reaction of the active material when the electrode is used as a capacitor plate.

For all of these devices, researchers have paid a great deal of attention to physical structure that allows direct contact between the active material and the elements, compounds, or ions that it reacts with or acts upon. For instance, research has focused on how ions move in and out of channels in crystalline active materials in rechargeable batteries, on how ions move through coatings on active materials, and how they are blocked by solid electrolyte interphase (SEI) layers.

In contrast, electrode structure has received relatively little attention and this attention has focused on very basic design features, such as mixing conductor particles and a binder with the active material to form the electrode or providing a simple nickel-foam substrate for the active material, or flagrant problems that result in near or complete failure of the device, such as delamination of active material films from current collectors (typically metal foils), or lack of contact between the active material and conductor particles surrounding it due to contraction and expansion of the active material during use of the device.

The electrode structure, which determines the electrical conductivity to, ionic conductivity to and degree of adhesion of active material, may be modified if materials alternative to metal foils are adopted as the substrate and current collector. To promote enhanced electrical conductivity and adhesion when using a metal foil, it is generally necessary to incorporate additional, inactive materials to promote these properties, thereby decreasing the porosity and increasing the tortuosity of the electrode, which results in decreased ionic conductivity to the active material.

### SUMMARY

The present disclosure includes an electrode that includes an electrically conductive, porous aerogel having pores. The aerogel includes an electrically conductive graphene oxide having functional groups and a polymer covalently bonded, physically bonded, or both to the reduced graphene oxide. The electrode further includes an active material covalently bonded, physically bonded, or both to the porous aerogel within the pores.

In more specific variations, each of which may be combined with one another or with any other aspect or feature of an aerogel or electrode discussed herein unless clearly not compatible, i) the polymer may be crosslinked; ii) the electrically conductive graphene oxide may include reduced graphene oxide; iii) the bonded active material may be bonded to at least a portion of the functional groups; iv) the bonded active material may be bonded to the polymer; v) the polymer may include poly(acrylic acid); vi) the active material may include lithium iron phosphate, such as carbon coated lithium iron phosphate, vii) the active material may include graphite; viii) the electrode may have a porosity of at least 5%; ix) the active material may participates in an electrochemical reaction, or x) the active material may catalyze an electrochemical reaction.

The disclosure further relates to a method of forming an electrode, such as any electrode as described above or elsewhere herein. The method includes covalently bonding, physically bonding, or both a polymer to an electrically-conductive graphene oxide, forming an aerogel, and covalently bonding, physically bonding, or both an active material to the aerogel.

In specific variations, each of which may be combined with one another or with any other aspect or feature of a method discussed herein unless clearly not compatible, i) the method includes introducing a slurry containing active material into the aerogel prior to its bonding to the aerogel; ii) at least two of the three steps occur simultaneously, or iii) bonding the active material to the aerogel occurs during use of the aerogel in an electrochemical device.

The disclosure also relates to a battery including at least one electrode as described above or elsewhere herein or formed using the method described above or elsewhere herein.

In specific variations, each of which may be combined with one another or with any other aspect or feature of a method discussed herein unless clearly not compatible, i) the battery has per area capacity of its electrodes of at least 2 mAh/cm²; ii) the battery is rechargeable and retains at least 85% of its capacity after the first charge/discharge cycle for at least 500 additional cycles.

The disclosure also relates to a fuel cell including at least one electrode as described above or elsewhere herein or formed using the method described above or elsewhere herein.

The disclosure also relates to an electrochemical sensor including at least one electrode as described above or elsewhere herein or formed using the method described above or elsewhere herein.

The disclosure also relates to an ultracapacitor including at least one plate including at least one electrode as described above or elsewhere herein or formed using the method described above or elsewhere herein.

### BRIEF DESCRIPTION OF THE DRAWINGS

A more complete and thorough understanding of some embodiments and advantages of the invention may be acquired by referring to the following description taken in conjunction with the accompanying drawings, which are not to scale.

FIG. 1A is a top view schematic drawing of an aerogel containing reduced graphene oxide and crosslinked polymer.

FIG. 1B is a cross-sectional schematic drawing of an aerogel on a substrate.

FIG. 1C is a cross-sectional schematic drawing of an aerogel on an embedded substrate.

FIG. 1D is an electron micrograph of an aerogel containing reduced graphene oxide and thermally crosslinked poly(acrylic acid).

FIG. 2A is a cross-sectional schematic drawing of a particle of active material directly bonded to an aerogel.

FIG. 2B is a cross-sectional schematic drawing of a particle of active material partially embedded in and directly bonded to an aerogel.

FIG. 2C is a cross-sectional schematic drawing of a particle of active material indirectly bonded to an aerogel via a conductive additive.

FIG. 2D is a cross-sectional schematic drawing of a particle of active material indirectly bonded to an aerogel via a polymer binder.

FIG. 2E is a cross-sectional schematic drawing of an aerogel coated with and directly bonded to active material.

FIG. 2F is a cross-sectional schematic drawing of a particle of active material indirectly bonded to an aerogel via a particle coating.

FIG. 2G is an electron micrograph of an aerogel containing reduced graphene oxide and thermally crosslinked poly(acrylic acid) and bonded carbon-coated lithium iron phosphate (LiFePO₄) active material.

FIG. 2H is an electron micrograph of an aerogel containing reduced graphene oxide and thermally crosslinked poly(acrylic acid) and embedded and bonded carbon-coated lithium iron phosphate (LiFePO₄) active material.

FIG. 3A is a top view schematic drawing of an aerogel with bound active material particles when the aerogel is in an uncompressed state.

FIG. 3B is a top view schematic drawing of the aerogel of FIG. 3A when the aerogel is in a compressed state.

FIG. 4 is a schematic drawing of a cross-section of a coin cell battery containing an aerogel-active material electrode.

FIG. 5 is a schematic drawing of cross-section of a hydrogen fuel cell containing an aerogel-active material electrode.

FIG. 6 is a schematic drawing of a cross-section of a sensor containing an aerogel-active material electrode.

FIG. 7 is a schematic drawing of a cross-section of an ultracapacitor containing an aerogel-active material electrode.

FIG. 8A is a photograph of an aerogel on a copper foil substrate bent to 90 degrees.

FIG. 8B is a photograph of the aerogel of FIG. 8A bent to 180 degrees.

FIG. 8C is a photograph of the aerogel of FIGS. 8A and 8B after it was released from the 180 degree bent state.

FIG. 9A is a graph of the lithium (Li) insertion capacity of a carbon coated lithium iron phosphate (LiFePO₄)—reduced graphene oxide-poly(acrylic acid) electrode per unit mass of active material.

FIG. 9B is a graph of the lithium (Li) insertion capacity of a carbon coated lithium iron phosphate (LiFePO₄)—reduced graphene oxide-poly(acrylic acid) electrode per unit area of electrode footprint.

FIG. 10A is a graph of specific discharge capacity of an embedded carbon coated lithium iron phosphate (LiFePO₄)—reduced graphene oxide-poly(acrylic acid) electrode per unit mass of active material.

FIG. 10B is a graph of the specific discharge capacity of an embedded carbon coated lithium iron phosphate (LiFePO₄)—reduced graphene oxide-poly(acrylic acid) electrode per unit area of electrode footprint.

FIG. 11A is a graph of lithium (Li) insertion capacity of a graphite—reduced graphene oxide-poly(acrylic acid) electrode per unit mass of active material.

FIG. 11B is a graph of lithium (Li) insertion capacity of a graphite—reduced graphene oxide-poly(acrylic acid) electrode per unit area of electrode footprint.

FIG. 12A is a graph showing linear voltammetry results for reducing potentials for a reduced graphene oxide-poly(acrylic acid) aerogel with a protective coating.

FIG. 12B is a graph showing linear voltammetry results for oxidizing potentials for a reduced graphene oxide-poly(acrylic acid) aerogel with a protective coating.

### DETAILED DESCRIPTION

The present disclosure relates to an electrode including an active material bonded to a porous electrically conductive graphene oxide-polymer aerogel. The present disclosure further relates to electrochemical devices, such as batteries, fuel cells, electrochemical sensors, and pseudocapacitance ultracapacitors containing such electrodes. The disclosure further relates to methods of forming and using the aerogels and electrochemical devices.

### Electrode

Electrodes of the present disclosure include a porous electrically conductive graphene oxide-polymer aerogel, to which an active material is bound.

Electrically conductive graphene oxide may include the reduced graphene oxide discussed by way of example herein. However, it may also include other electrically conductive graphene oxides, such as a graphene oxide that has not been oxidized to the point where it is no longer electrically conductive, making subsequent reduction unnecessary. Electrically conductive graphene oxide may further include any graphene oxide that is treated in any manner until it has an electrical conductivity of at least 0.0001 S/cm, or that has not been oxidized to have an electrical conductivity of less than 0.0001 S/cm. Electrically conductive graphene oxide may have a carbon (C) to oxygen (O) ratio of at least 6.

Electrical conductivity, as used herein, refers to what is measured using a two point probe method connected to a voltage/current meter, such as an impedance meter, which measures the opposition that a circuit presents to a current when a voltage is applied. In this method, the sample is stationed in a fixed distance inbetween the two metal electrodes of the meter. Additional conductive adhesives, such as silver (Ag) paste or copper (Cu) adhesive, maybe placed between the sample and either or both electrodes to minimize the contact resistance. Regardless of whether the sample is electrically conductive graphene oxide, an aerogel, or an electrode, it should not be compressed, particularly in the direction perpendicular to the electrodes, during the electrical conductivity test, as compression increases the number of conductive pathways in the sample. Electrical conductivity measured between two electrodes of the two-point probe system represents the apparent conductivity of the material, not the intrinsic conductivity.

### Aerogel Composition and Structure

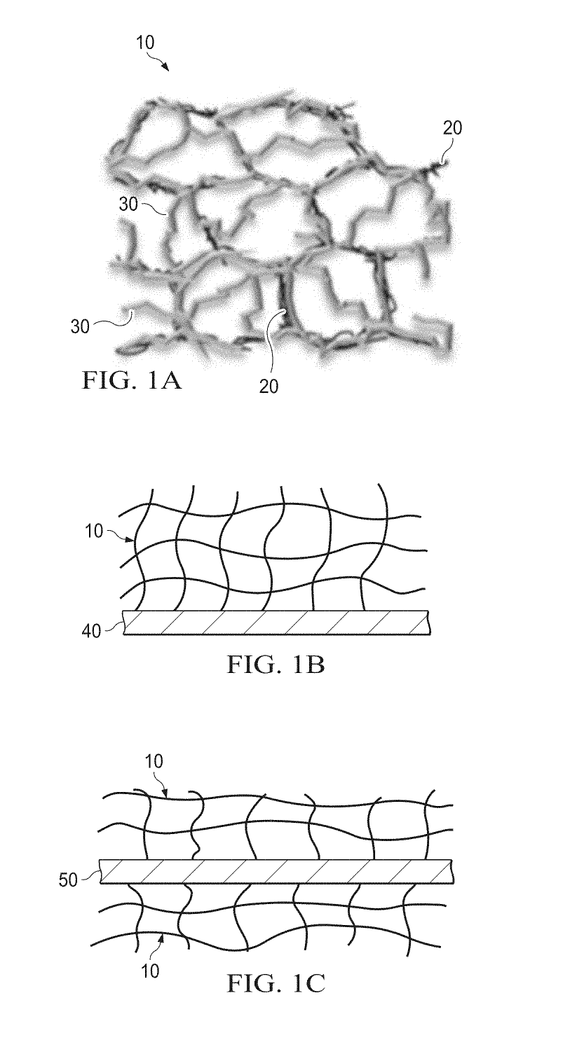

As illustrated in FIG. 1A, an aerogel 10 of the present disclosure includes reduced graphene oxide 20 with covalently bonded functional groups (not shown). Aerogel 10 further includes polymer 30 covalently or physically bonded, or both to graphene oxide 20 and that many be crosslinked within its structure. In covalent bonds, two atoms share electrons. Covalent bonds include sigma bonds and pi bonds. In physical bonds, two atoms or compounds are attracted to one another without electron sharing. Physical bonds include hydrogen bonds, van der Waals bonds, ionic bonds, and ion-pi bonds. Typically, polymer 30 is bonded to functional groups on reduced graphene oxide 20. An electron micrograph of an aerogel of FIG. 1A is provided in FIG. 1D.

Reduced graphene oxide 20 with functional groups may include any graphene oxide that has been reduced by chemicals, heat, or a microwave or light source. For instance, reduced graphene oxide 20 may be produced by chemical functionalization and physical exfoliation of high purity graphite through stirring or sonication, such as using Hummer's method or a modification thereof. This graphene oxide sheet contains functional groups covalently bonded to the carbon rings, such as carboxylic acids, hydroxyls, and epoxides. The graphene oxide sheet is then treated with a reducing agent, such as hydrazine, hydriodic acid, and ascorbic acid, which reduces the functional groups. After forming an aerogel, the resulting material is a sheet of reduced graphene oxide rings 20 with residual functional groups. Although the functional groups typically include a variety of different functional groups, reduced graphene oxide 20 may also contain only one type of functional group.

Some functional groups may primarily form covalent bonds with polymer 30 or other material bonded to the aerogel, but hydroxyl, carboxylic acid, and epoxy groups are capable of forming both covalent bonds and physical bonds.

Polymer 30 may include any polymer or combination of polymers able to bond to reduced graphene oxide 20. For instance polymer 30 may be one or a combination of any of the following:
i) poly(acrylic acid),
ii) poly(vinyl alcohol),
iii) a polymer with a maleic anhydride functionality,
iv) a polyamide,
v) a poly(acrylamide)
vi) a poly(acrylic anhydride), which forms strong hydrogen bonds,
vii) poly(vinyl naphthalene)
viii) poly(styrene)
ix) a polymer with aromatic rings in the polymer backbone or the pendent group which form strong pi-pi interactions
x) a thermoplastic elastomer such as polyurethane
xi) an ethylene oxide and propylene oxide block copolymer, such as Pluronic® (BASF, US)
xii) a polystyrene and rubber block copolymer, such as a polystyrene and polybutadiene, polyisoprene, or their hydrogenated equivalent block copolymer, particularly a triblock copolymer with polystyrene at the extremities such as Kraton® polymers (Kraton Polymers, US)
xiii) a general polymer, such as polypropylene, polyethylene, and poly(methyl methacrylate)
xiv) a specialty polymer, such as polyimide, polytetrafluoroethylene, and polyethylene oxide, and
xiv) any copolymer containing at least two different monomer units.

Polymer 30 may require or benefit from further treatment, such as chemical treatment, heat treatment, or UV crosslinking, in forming crosslinks. Crosslinking polymer 30 can increase the mechanical integrity of aerogel 10.

Particularly when polymer 30 is a combination of polymers, it may include one or more polymers that primarily bond to reduced graphene oxide 20, and one or more polymers that primarily crosslink the first polymer(s). For instance, polymer 30 may include poly(vinyl alcohol) bonded to reduced graphene oxide 20 and glutaraldehyde crosslinking the poly(vinyl alcohol).

Polymer 30 may be linear or branched and it may be a homopolymer or a copolymer. Polymer 30 may be able to react with active material 60 or another material loaded onto aerogel 10 to form an electrode. In addition, polymer 30, after bonding to reduced graphene oxide 20, to active material 60, or to another material loaded onto aerogel 10, after further treatment, or after any combination of the above, may not substantially react with materials encountered by the electrode during its normal use. For instance, polymer 30 may not react with the ion or electrolyte in a battery or fuel cell, the sample fluid or air in a sensor, or the dielectric in an ultracapacitor.

Aerogel 10 may be synthesized by removing liquid from a dispersion of a compound. Aerogel 10 may include polymer 30 in the range of 10 wt % to 90 wt %. The degree of crosslinking density and the molecular weight of the polymer may vary based on the mechanical integrity to be achieved in aerogel 10. The porosity, flexibility, compressibility, specific area, and electrical conductivity of aerogel 10 or an electrode containing aerogel 10 may vary based on the amount of polymer 30 present, the amount of crosslinking, and the composition of polymer 30.

Aerogel 10 may be a free-standing aerogel as depicted in FIG. 1A. However, it may also contain other components that provide mechanical support, flexibility, additional electrical conductivity, or other physical characteristics. For instance, aerogel 10 in FIG. 1B is located on an external substrate 40. Aerogel 10 in FIG. 1C contains an internal substrate 50.

In either case, the substrate may be a metal foil or mesh. Although not needed in all instances due to the intrinsic electrical conductivity of reduced graphene oxide, the metal foil or mesh may provide additional electrical conductivity. The metal foil or mesh may be flexible due to its intrinsic ductility. The metal foil or mesh may also provide physical support for the aerogel during its manufacture or its use, or both.

The substrate may also be a membrane, such as a carbon or silicon polymer membrane. The membrane may be electrically conductive, but it need not be. The membrane may be sufficiently porous to not disrupt the ionic conductivity of the aerogel once formed into an electrode. The membrane may provide flexibility and also physical support for the aerogel during its manufacture or its use, or both.

### Electrode Composition and Structure

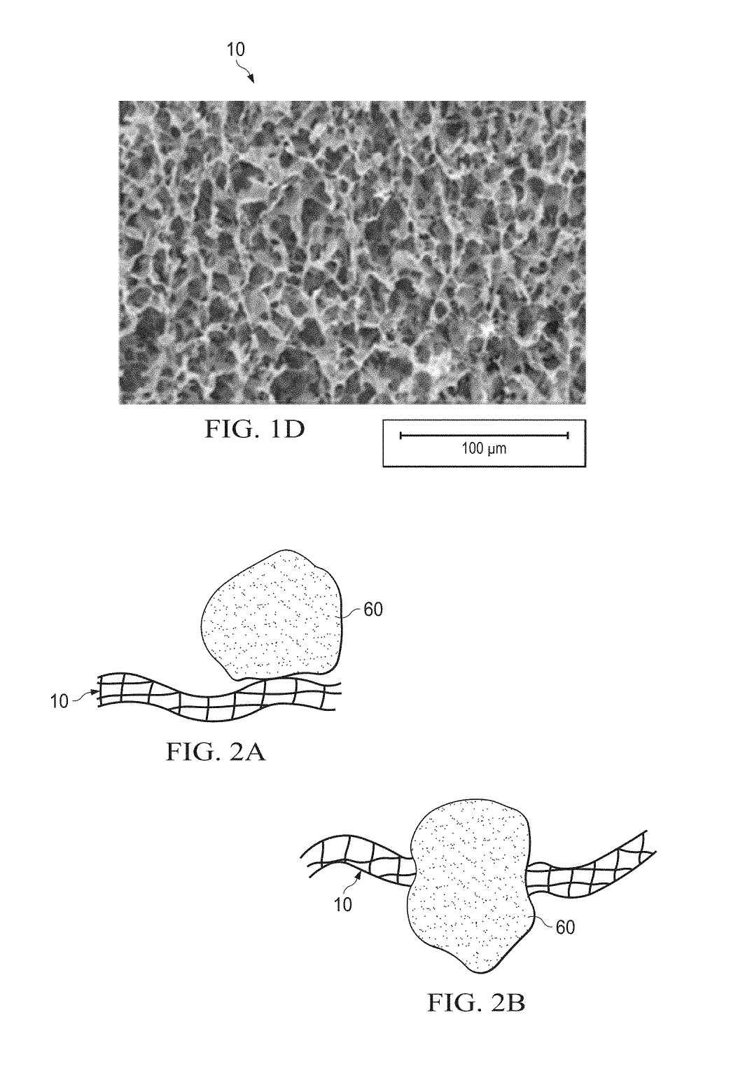

As illustrated in FIGS. 2A-G, the active material 60 may be bonded to aerogel 10 to form an electrode, which provides electrical conductivity as well as physical retention and support for active material 60. Active material 60 may be bonded via a covalent bond or a physical bond, or both. The bond may be directly between active material 60 and aerogel 10, for example as illustrated in FIGS. 2A, 2B, and 2G. It may also be indirect, with one or more intervening bonded materials, for example as illustrated in FIGS. 2C, 2D, 2E, and 2F. Direct bonding provides active material 60 with direct electrical contact with the electrically conductive graphene oxide 20. If active material 60 is indirectly bonded, then the intervening bonded materials may be electrically conductive.

Active material 60 may be bonded to reduced graphene oxide 20, polymer 30, or both. If bonded to reduced graphene oxide 20, active material 60 may be bonded to the carbon structure, to functional groups, or both. If bonded to polymer 30, active material 60 may be bonded to the polymer backbone, any functional groups, or both.

Reduced graphene oxide 20 or aerogel 10 may be treated to form functional groups, such as functional groups on reduced graphene oxide 20 or polymer 30, or both, that facilitate bonding to active material 60.

Active material 60 may include an electrochemically active material that can bond to aerogel 10. This includes most active materials in present electrochemical devices, such as battery anode active materials and cathode active materials, as well as fuel cell catalysts, redox reaction participants or mediators in electrochemical sensors, and pseudocapacitance redox reaction participants on ultracapacitors.

A free-standing electrode without a substrate and formed from active material 60 may include at least 75% active material by weight, at least 80% active material by weight, at least 90% active material by weight, or at least 95% active material by weight. A free-standing electrode with a substrate and formed from active material 60 may include at least 50% active material by weight. If active material 60 has a coating, such as that described in FIGS. 2F and 2G, that is integral with the active material, the coating may be considered part of the active material for weight % purposes. Similarly, if aerogel 10 has an integral coating, then that coating maybe considered part of the aerogel for weight % purposes. If the electrode includes other non-aerogel components, such as conductive additive or a polymer binder, then the electrode may include at least 80% non-aerogel components by weight, at least 85% non-aerogel components by weight, at least 95% non-aerogel components by weight, or at least 99% non-aerogel components by weight.

In particular, active material 60 for battery cathodes may be or include at least one transition metal or transition metal alloy or compound. For instance, active material 60 may include titanium (Ti), vanadium (V), chromium (Cr), manganese (Mn), iron (Fe), cobalt (Co), nickel (Ni), copper (Cu), niobium (Nb), molybdenum (Mo), and cadmium (Cd), and alloys or compounds thereof. Active material 60 may further include non-transition metals, such as lithium (Li), sodium (Na), magnesium (Mg), or Aluminum (Al) particularly if the non-transition metal is the working ion. Active material 60 for battery cathodes may include a metal-non-metal compound, such as a metal oxide or a metal oxide polyanion, such as a metal phosphate.

Active material 60 for battery anodes may be or consist essentially of nothing more than a metal, such as Li, Na, Mg, or Al. Active material 60 for anodes may also include carbon (C), aluminum (Al), silicon (Si), sulfur (S), transition metal oxides including titanium oxide, vanadium oxide, chromium oxide, iron oxide, cobalt oxide, nickel oxide, copper oxide, zinc oxide, zinc, germanium (Ge), selenium (Se), tin (Sn), antimony (Sb), lead (Pb) and alloys and oxides of these.

Specific examples of active material 60 are discussed in the Electrochemical Devices Section and Examples below. Active material 60 may include not only these materials, but also other active materials known to be interchangeable therewith. Furthermore, active material 60 may include a single type of active material, or combinations of different active materials. Particularly during use of an electrochemical device, such as during use of a battery, active material 60 may include different active materials, one representing a charged state, and another representing a discharged state, such as a combination of LiFePO₄ and FePO₄ in the cathode of a rechargeable lithium ion battery when it is partially discharged.

The porosity, flexibility, compressibility, specific area, and electrical conductivity of the electrode may vary based on the amount of active material 60 present, how active material 60 is bonded to aerogel 10, the physical locations of active material 60 on aerogel 10, whether active material 60 is present as discrete physical entities and the nature of such entities, and the composition of active material 60.

Although the present specification focuses on single active materials, combinations of active materials may also be used. In the case of combinations, one or more active materials may be bonded to aerogel 10, while one or more are not, or all active materials may be bonded. Active materials may differ in their bonding sites for aerogel 10. For instance, one active material may bond to reduced graphene oxide ring 20, while another bonds to polymer 30. One active material may bond to one functional group, while another active material bonds to another functional group. Differences in functional group bonding may also be seen on polymers. Differences in the polymers to which different active materials bond may be seen with mixed polymers. In another variation, one active material may bond to aerogel 10, while a second active material bonds to the first active material, forming two layers of active materials.

Active material 60 may have a crystal structure that allows it to intercalate and deintercalate the working ion. This crystal structure may be preserved overall for each physical entity of active material 60 after loading onto and bonding to aerogel 10 to form an electrode, even if it is lost in small regions of each physical entity due to bonding or steric hindrance.

In addition, active material 60 may have a chemical formula that allows it to gain and lose the working ion, for example by alloying and de-alloying or by storing charge via conversion reactions with a chalcogenide, such as reversible formation of Li₂O with certain metal oxides. This chemical formula may be preserved overall for each physical entity of active material 60 even after loading onto and bonding to aerogel 10, even if some molecules of active material 60 in the physical entity lose this capacity due to bonding.

Disruption of the chemical formula or crystal structure of active material 60 by bonding to aerogel 10 may not occur if active material 60 has a coating, as this coating material, not the active material, bonds to aerogel 10.

Active material 60 may be electrochemically active or in a final form when bonded to aerogel 10 to form an electrode, or it may require that the electrode be charged or discharged, or both at least once in order to become electrochemically active or to assume a final form. Active material 60, particularly if it is essentially only a metal, such as the working ion, may not bond to aerogel 10 until the electrode has been charged or discharged, or both.

Active material 60, any intervening materials, or both may be bonded to aerogel 10 during or after manufacture of aerogel 10, depending on the manufacturing conditions and active material configuration to be obtained.

Although active material 60 is depicted as a particle in FIGS. 2A-D, F, and G, it may be any discrete physical entity having any shape or size, including rods, irregular shapes, and agglomerates. Active material 60 may also include a plurality of discrete physical entities that do not have a uniform size or shape.

If active material 60 is in the form of discrete physical entities, this allows any disruption of the functionality of such entities to be localized. For instance, if one particle detaches from aerogel 10, then only that particle and perhaps a few particles in near proximity, such as within a few particle lengths, on top of and to the side of it are affected. In addition, the effects of any expansion or contraction of discrete physical entities of active material 60 can be minimized by adjustment of the degree of compression of the aerogel, which determines porosity and the volume of space allowed for particle expansion. Because of the three-dimensional structure and arrangement of particles, the risk of particle fracture or detachment resulting in significant film delamination is much less than in other electrodes, as the active material can change size without harming electrode integrity so long as it remains covalently or physically bound, or both to aerogel 10. This property may allow the use of active materials previously deemed unsuitable for electrochemical devices because they expand and contract too much to remain in contact with components of traditional electrodes.

Regardless of the shape or form, discrete physical entities of active material 60 may, on average, be smaller in their largest dimension than the average diameter of pores in aerogel 10. This allows active material 60 to enter the pores. To facilitate easier entry into pores prior to bonding, discrete physical entities of active material 60 may, on average, be smaller in their largest dimension that 75%, 50%, 25%, 10%, or 5% of the average diameter of pores in aerogel 10. Discrete physical entities may be introduced into aerogel 10 via a slurry to facilitate their movement into the aerogel.

In FIG. 2A, active material 60 is directly bonded to aerogel 10. It may be bonded to the carbon of reduced graphene oxide 20, or to functional groups on reduced graphene oxide 20, or both. It may in addition or alternatively be bonded to the backbone of polymer 30, or to functional groups on polymer 30, or both.

In some instances, active material 60 may also be covalently or physically bonded to aerogel 10 during manufacture of aerogel 10. For example, in FIG. 2B, active material 60 is not only directly bonded to aerogel 10, it is also partially embedded within it. Typically this configuration is obtained by adding active material 60 during manufacture of aerogel 10, rather than afterwards. Variations include active material 60 that is not directly bonded to aerogel 10, but is still embedded within it, such as active material 60 that has a coating like that further illustrated in FIG. 2H. Embedding active material 60 within aerogel 10 may improve electrical conductivity to active material 60 and may also improve adhesion of active material 60 to aerogel 10.

In FIG. 2C, active material 60 is indirectly bonded to aerogel 10 via conductive additive 70. As illustrated, conductive additive 70 is bonded to aerogel 10 and to active material 60. Active material 60 may also be bonded to aerogel 10 via a longer chain of conductive additives 70. Conductive additive 70 includes any conductive additive otherwise used in an electrode. For instance, it may include an electrical conductivity enhancer, such as a carbon conductivity enhancer, including carbon black and graphite. Conductive additive 70 is illustrated as particles in FIG. 2C, but it may be in any shape or size and may be a mixture of multiple types of conductive additives. For instance, if conductive additive 70 is in the form of particles larger than particles of active material 60, a conductive additive particle may be bonded to aerogel 10 and have multiple active material particles 60 bound to it.

In FIG. 2D, active material 60 is indirectly bonded to aerogel 10 via a polymer binder 80. Polymer binder 80 may include any polymer binders used in electrodes. Polymer binder 80 is illustrated as attached at one end to aerogel 10, but it may be attached at any location along the polymer to active material 60 or aerogel 10. They may also be attached at more than one location to active material 60 or to aerogel 10. Furthermore, polymer binder 80 may be in the form of coating on aerogel 10, similar to the active material coating shown in FIG. 2E. Active material 60 may be bonded to more than one polymer strand of polymer binder 80 and may be bonded to aerogel 10 through a chain of polymer binders 80.

Active material 60 may also not be in the form of discrete physical entities; it may also be a coating or film, such as that illustrate in FIG. 2E, where aerogel 10 is coated with active material 60. A coated active material 60 is often directly bonded to aerogel 10, but need not necessarily be. For instance, aerogel 10 may be coated with a polymer binder to which the coated active material bond, resulting in an indirect bond between the coated active material 60 and aerogel 10.

Aerogel 10 may be coated with active material 60 during manufacture of the electrode or during use of the electrode, or both. For instance, if active material 60 is a metal, then it may electrodeposit out of an electrolyte during charge or discharge of a battery.

Although the coating illustrated in FIG. 2E is uniformly thick and covers both surfaces of aerogel 10, it need not be uniform in thickness and need not cover all of the available surfaces of aerogel 10; for instance, it may be located on only one side of aerogel 10.

Coated active material 60 that is deposited and removed at least partially during cycling of the electrode, for example in a rechargeable battery, may also be free from problems caused by cycling of active materials that remain on the electrode, such as changes in size, because the coating is at least partially reformed with each cycle, which also tends to localize the impact of any detachment from aerogel 10.

In addition, if active material 60 is a metal coated on aerogel 10 during charge or discharge of a battery, particularly a rechargeable battery, the coating may be formed by electrodeposition of metal from their metallic ions on pore walls within the aerogel. This electrodeposition may be controlled primarily by ion diffusion rather than by electric fields because in the event there is a high density of metal deposits on the pore walls of the aerogels, a Guassian-like surface will be created, preventing sharp electric fields and thereby decreasing the hazard of forming dendritic-like electrodeposits.

Electrodeposition may further be used to form discrete physical entities of active material 60, depending on the nature of the active material. In this case, a Gaussian-like surface may not result, so electrodeposition may be more complex. However, even electrodeposition of discrete physical entities of some active materials 60 may result in a Gaussian-like surface and thus be controlled by ion diffusion rather than electric fields.

In FIG. 2F, active material 60 is coated with particle coating 90. Particle coating 90 may include an electrically conductive coating that also permits ion flow into and out of active material 60. For instance, particle coating 90 may be a carbon coating such as those used in connection with lithium metal phosphate cathode active materials and titanate anode materials.

One example of such a coated active material 60 bonded to an aerogel 10 is shown in FIG. 2G, which is an electron micrograph of an aerogel containing reduced graphene oxide and thermally crosslinked poly(acrylic acid) and bound to carbon-coated lithium iron phosphate (LiFePO₄) active material. A coating may also include a protective coating, such as a silica-based coating to inhibit SEI formation, promote ion transport, exclude unwanted polymers or water, or any combination thereof.

FIGS. 2A-G present merely some configurations of an electrode containing aerogel 10 and active material 60. Other variations combining or repeating the elements of FIGS. 2A-G or adding further elements are possible. For instance, the electrode may be more complex and contain active material 60, conductive additive 70, and polymer binder 80. Different particles of conductive additive 60 may be bonded to aerogel 10 differently. For instance, some may be directly bonded, some bonded via conductive additive 70, some through polymer binder 80, and some through both conductive additive 70 and polymer binder 80. In addition, agglomerates of any of these or other materials may be bonded to aerogel 10.

Similarly, although aerogel 10 is depicted as a sheet, it may also be of any shape or size. It may further contain a substrate as illustrated in FIGS. 1B and 1C.

An electrode formed from aerogel 10 and active material 60 may further contain other materials commonly used in electrodes, such as ion donors to reduce capacity loss over time. In addition, the electrode may be able to function as a free-standing electrode electrically connected to wires or other conductors that merely transfer current outside of an electrochemical device containing the electrode. However, the electrode may also contain a current collector, such a substrate 40 or 50 or a metal mesh or foil. However, the addition of other materials that add weight but are not electrochemically active may reduce energy density, power density, or other mass-based properties of an electrochemical device containing the electrode and, therefore, may be avoided when possible for electrochemical devices where mass-based properties are a concern.

The porosity, flexibility, compressibility, specific area, and electrical conductivity of an electrode formed from aerogel 10 may also vary based on the amount, identity, location, and bonding, if any, of any additional materials present.

An electrode material formed from aerogel 10 and active material 60 is primarily discussed herein as a physical entity that forms an electrode, but the electrode material may also be dispersed, for instance as particles, within a larger physical entity to form an electrode.

Aerogel 10 and an electrode formed from it are porous, with pores surrounded by reduced graphene oxide 20 and polymer 30 and, when present, lined with active material 60 or other materials bound to aerogel 10. In particular, aerogel 10 may have an uncompressed porosity (pore volume/total aerogel volume (including anything bound to the aerogel, such as active material) of at least 90%, at least 95%, at least 98%, or at least 99%. Addition of active material 60 reduces the porosity of aerogel 10 because active material 60 occupies pore space. Thus the porosity of an uncompressed electrode formed from aerogel 10 may be between 5% and 95%, between 25% and 75%, between 40% and 60%, at least 25%, at least 40%, at least 50%, at least 60%, or at least 75%.

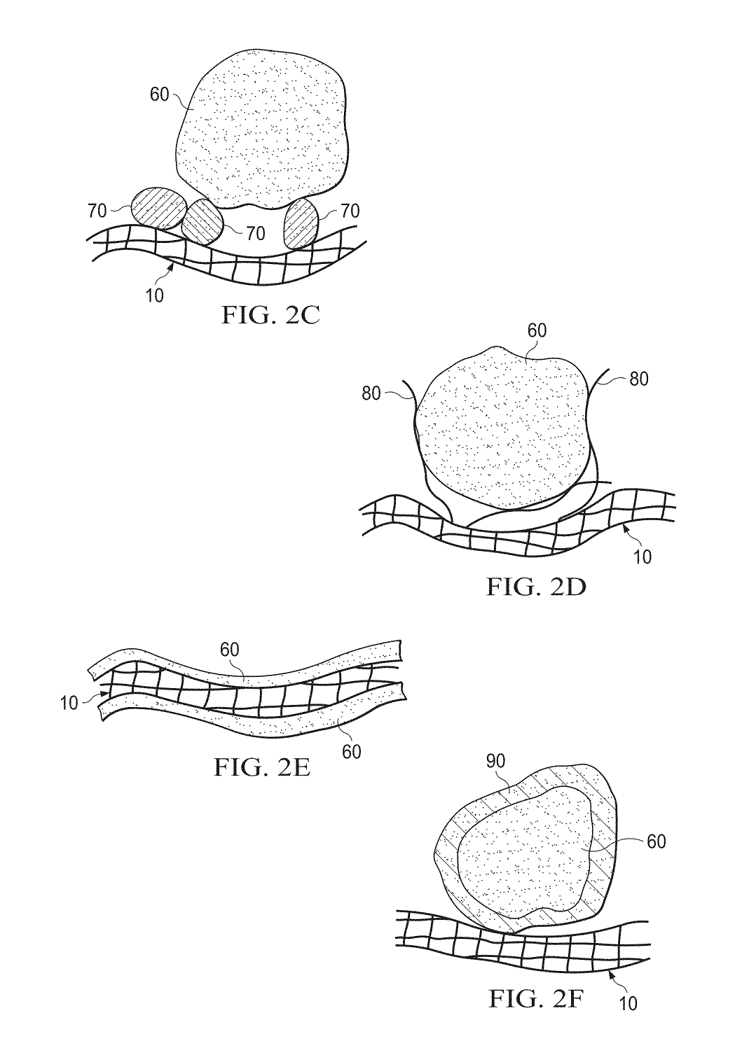

Aerogel 10 and an electrode formed from it are compressible as illustrated in FIGS. 3A and 3B. In FIG. 3A, representing an uncompressed electrode, both particles of active material 60 located in pores of aerogel 10 and the pore walls of aerogel 10 are spaced further from one another and the pores are larger than in FIG. 3B, representing a compressed electrode. In particular, aerogel 10 or an electrode formed from it may be compressed to a volume no more than 70%, no more than 50%, no more than 25%, or no more than 5% of its uncompressed volume while still retaining a porosity of at least 5%. A compressed electrode formed from aerogel 10 may have a porosity of between 20% and 70%, between 35% and 55%, at least 20%, at least 35%, at least 45%, at least 55%, or at least 70%.

The electrode may be compressed to decrease its porosity, increase its density, to increase its electrical conductivity by increasing the number of contact points between aerogel 10, active material 60, and conductive additive, if present, or any combination thereof. For instance, the electrode may be compressed to increase its density and thus the energy density, power density, or other mass-based property of a battery or electrochemical device containing the electrode.

In addition, if the porosity of an electrode formed from aerogel 10 is reduced, for example by compression, or if the electrode otherwise has such limited porosity that its function is impaired, the electrode may be aerated. For instance, it may be aerated by mechanically driven puncturing, laser cutting, or both. The electrode may also otherwise be treated to restore porosity to a particular level. In particular, if not sufficiently porous, the electrode may exhibit limited working ion diffusivity, which may reduce the effective ionic conductivity of the electrolyte within the electrode and cause detrimental electrode polarization. This problem may be particularly detrimental for electrochemical devices, including many present commercial devices, that rely on a diffusion-controlled redox reaction. Patterned and regular aeration or other treatment of the electrode may introduce channels, such as microchannels, that facilitate ion diffusion through the electrode without deforming or fracturing the electrode formed from aerogel 10.

Aerogel 10 or an electrode formed from it may have a density of 2 mg/cm³ or higher, 5 mg/cm³ or higher, or 10 mg/cm³ or higher, 20 mg/cm³ or higher, 50 mg/cm³ or higher, 75 mg/cm³ or higher, or 100 mg/cm³ or higher. Aerogel 10 or an electrode formed from it may have a density between 2 mg/cm³, 10 mg/cm³, or 20 mg/cm³, and 50 mg/cm³, 75 mg/cm³, or 100 mg/cm³, in any combinations. Electrode porosity and density may be altered by compressing or aerating the electrode. An electrode formed from aerogel 10 may have a total electrode density of at least 100 mg/cm² of electrode projected surface area, at least 500 mg/cm² of projected surface area, at least 1 g/cm² of electrode projected surface area, at least 2 g/cm² of electrode projected surface area, or at least 5 g/cm² of electrode projected surface area.

Active material 60 with a high tap density may particularly benefit from use in an electrode of the present disclosure. High tap density materials are difficult to process into thick electrodes; thick electrodes tend to be difficult to form into films with good adhesion, particularly when flexed, and thick electrodes tend to have poor ionic and electrical conductivity for particles far from the opposite electrode and far from the current collector, respectively. Aerogel 10 provides ionic and electrical conductivity sufficient to overcome these problems for many high tap density active materials 60.

An electrode formed from aerogel 10 may be any shape and size, which allows it to be used in a broad array of electrochemical devices. Unlike reduced graphene oxide aerogels that do not incorporate polymer, aerogel 10 prior to formation of an electrode or an electrode formed from aerogel 10 may be cut without suffering significant compression or breakage. Reduced graphene oxide 20 or aerogel 10 may also be formed in a mold having the size and shape of an electrode to be formed from aerogel 10.

Aerogel 10 may have a specific area of at least 50 m²/g, at least 100 m²/g, or at least 500 m²/g. Generally, a higher specific area improves the ability to form an electrode from aerogel 10 so long as the dimensions of the pores of aerogel pore remain sufficiently large to accommodate active material and facilitate transport of the ions in the electrolyte filling the pores.

High specific area can sometimes lead to high levels of undesirable reactions between the electrode and its environment. For instance, the high surface area may reduce battery life if an electrode reacts with components of the electrolyte other than the working ion, such as a solvent or a by-product of electrochemical reactions at the other electrode, or a breakdown product. The high surface area may also reduce sensor life or accuracy if the electrode or a component thereof reacts with the sample tested.

In order to minimize or avoid unwanted reactions such as those which form a SEI upon anodes in lithium-ion batteries or the unwanted oxidation reactions occurring upon cathodes in lithium-ion batteries, the electrode may be coated with a conformal non-reactive coating, such as a dielectric coating. The coating may limit contact between the electrode and the material with which it will react. The coating may be applied after the electrode is formed or at any stage during its manufacture, so long as it does not otherwise interfere with reactions that form the electrode. For instance, a coating that leaves certain functional groups accessible, unreacted, and intact may be applied to aerogel 10, which then bonds to active material 60 via those functional groups. Suitable such coatings include dielectric oxides, such as Al₂O₃, SiO₂, other silica-containing or alumina-containing materials, or transition metal oxides. A coating of greater than 10, greater than 20, greater than 50 or greater than 100 monolayers of coating material, such as Al₂O₃, may render the electrode stable against electrolyte decomposition for potentials lower than 1.5 V, lower than 1.0 V, lower than 0.5 V or lower than 0.1 V vs the Li/Li⁺ redox potential and for potentials greater than 4.0 V, greater than 4.5 V, greater than 5.0 V, greater than 5.5 V vs the Li/Li⁺ redox potential.

Aerogel 10 or an electrode formed from it may also be flexible. In particular, a sheet measuring 1 cm in thickness may be able to be bent to at least a 90 degree angle, at least a 120 degree angle, or at least a 180 degree angle without breaking. This allows the electrode to be used in pouches or electrochemical device configurations designed to fit particular geometries or to be used in applications requiring a flexible battery. Aerogel 10 or an electrode formed from it, regardless of compression state and regardless of whether the material is wet or dry, may be wound around a metal rod no more than 10 mm in diameter, a metal rod no more than 5 mm in diameter, or a metal rod no more then 1 mm in diameter with visible cracking, breaking, or fracturing. This indicates that the material can be wound into a cylindrical cell, such as a jelly-roll cell commonly used for batteries. Including a flexible substrate, such as a substrate 40 or 50 formed from a metal foil or mesh may increase flexibility of aerogel 10 or an electrode formed from it.

However, and electrode formed from a free-standing aerogel 10, such as shown in FIG. 1A, also confers advantages that may outweigh the flexibility conferred by metal mesh or foil. By replacing or supplementing the traditional metal foil substrate and current collector in a conventional electrode with a three-dimensional and electrically conductive scaffold, it is possible to promote the properties of electrical conductivity to and adhesion of active material with a minimal amount of inactive, supporting materials and therefore avoid decreasing ionic conductivity to the active material.

Aerogel 10 or an electrode formed from it are electrically conductive. In particular, aerogel 10 or an electrode formed from it may have an electrical conductivity of between 0.0001 S/cm, 0.01 S/cm, 10 S/cm, or 10³ S/cm, in any combinations. The electrode may have an electrical conductivity sufficient to provide evenly distributed electron flow to all active material 60 within the electrode. The electrode may not experience accumulated iR drops that slow charging of some active material 60 due to insufficient electron transport, for example when used in a rechargeable battery.

The functional abilities of the electrode may be more tied to average electrical conductivity to active material 60, rather than bulk conductivity. The average electrical conductivity to active material 60, from the current source, such as the lead of an electrochemical device is determined by the combination of the intrinsic electrical conductivity of aerogel 10, distance to and average conductivity of any intervening materials bonding active material 60 to aerogel 10, or the distance between aerogel 10 and directly bonded active material 60. By minimizing the distance between aerogel 10 and active material 60, the effective electrical conductivity of the electrode may be determined primarily by tuning the electrical conductivity of aerogel 10 and the identity of active material 60. To support electrical conductivity of aerogel 10, active material 60, or both, a conductive coating on the aerogel 10, a conductive coating on active material 60, or both, may be used.

An electrode formed from aerogel 10 may further be ionically conductive for the working ion or other active ion throughout the electrode. The ionic conductivity through the electrode is achieved via liquid phase transport through the pores; the ions do not travel at appreciable rates through the solid aerogel 10. As a consequence, the ionic conductivity in the electrode is determined by the porosity and the tortuosity or the pores. The length of the liquid phase ionic path from point A to B within the electrode is the primary limiter of ionic transport. The electrode may be sufficiently ionically conductive for the working ion or other active ion to meet the needs of the electrochemical device containing it. For instance, the electrode may be sufficiently ionically conductive for the working ion in a rechargeable battery to meet the electronic current set by the charge or discharge rate for that battery. The effective ionic conductivity of an electrode formed from aerogel 10 may be at least 0.001 mS/cm, 0.01 mS/cm, 0.05 mS/cm, 0.1 mS/cm, 0.5 mS/cm, or 1 mS/cm.

The ionic conductivity of aerogel 10 is a consequence of the content of supporting materials used to promote electrical conductivity to and adhesion of active materials, the degree of compression of aerogel 10 in the electrochemical device, and other factors including deliberately formed microchannels and other microstructuring of aerogel 10. By promoting electrical conductivity to and adhesion of active material 60 via its direct contact with aerogel 10, a minimal content of these supporting materials is necessary, allowing for increased electrode porosity and decreased tortuosity with aerogel 10 and thereby promoting ionic conductivity.

### Methods of Manufacturing Electrodes

Electrodes containing aerogel 10 may be manufactured via one of two primary methods. In the first method, the aerogel 10 is formed first, then active material 60 is bonded to it. In the second method, active material 60 is present while aerogel 10 is forming and bonds to it during the aerogel formation.

Active material 60 may be in a final state before it is introduced to aerogel 10 or materials that form aerogel 10, or active material 60 may itself be formed, for instance, by reactions with aerogel 10, or by reactions when aerogel 10 is also forming.

Using any methods, active material 60 or a reactant that forms it may be introduced into aerogel 10 or reduced graphene oxide 20 while aerogel 10 or reduced graphene oxide 20 is in a stretched or uncompressed state to maximize active material loading.

### Electrochemical Devices

Any of a variety of electrochemical devices may use at least one electrode, such as electrode 110, that may be any electrode described herein or manufactured using the methods described herein. Four specific types of electrochemical devices are discussed below, but electrode 110 may be used in any electrochemical device employing an active material 60.

### Batteries

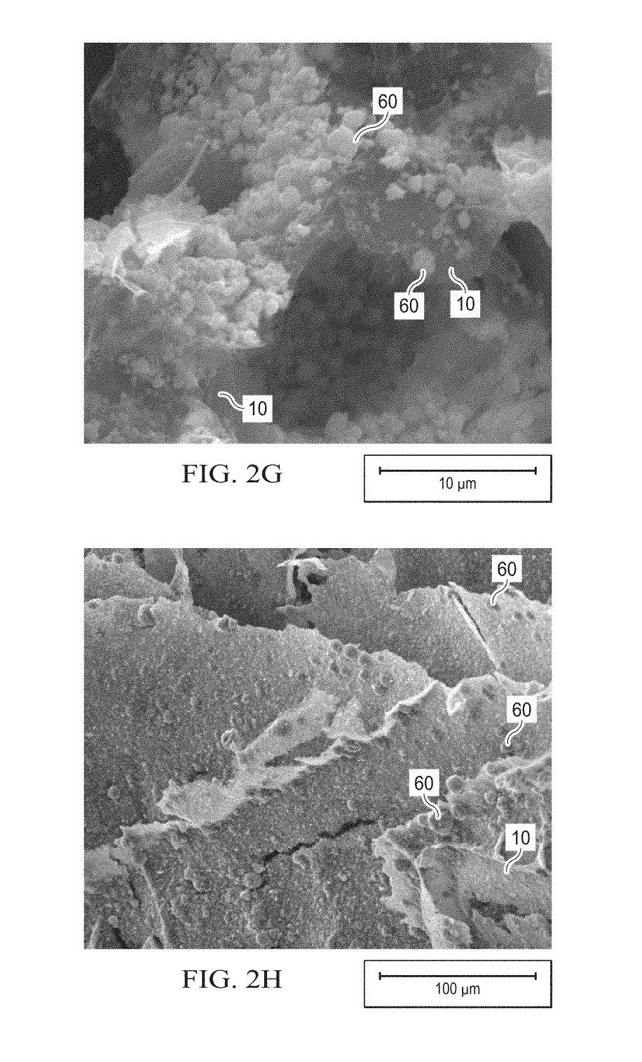

FIG. 4 is a schematic drawing of a coin cell 100 containing a cathode formed from electrode 110, a separator 120, electrolyte 130, anode 140, cathode can 150, and anode cap 160 sealed with gasket 170. Electrode 110 may be used in other battery formats as well, such as jelly-rolls, multi-cell batteries, and prismatic cells. Higher porosity electrodes have high ionic conductivity, which, in turn, provides higher power density at the expense of lower energy density and vice versa.

Batteries may range from simple electrochemical cells and simple combinations of cells in parallel or in series to complex batteries with monitoring, shutoff, and interface systems, including even computer systems. Batteries may be rechargeable (secondary) or non-rechargeable (primary) batteries.

Primary batteries compatible with electrode 110 include lead acid, zinc-carbon, zinc-chlorine, alkaline, such as Zn—MnO₂, nickel oxyhydroxide, such as Zn—MnO₂/NiOₓ, lithium, suhc as Li—FeS₂, Li—CuO, Li—MnO₂, Li—(CF)ₙ, and Li—CrO₂, Zn—O₂, Zn—Au, Ag/Zn—Ag₂O, and Mg—MnO₂ batteries.

Rechargeable batteries compatible with electrode 110 include lithium-ion batteries such as lithium-lithium metal phosphate batteries, including lithium iron phosphate, lithium manganese phosphate, lithium iron/manganese phosphate batteries, and lithium iron/cobalt phosphate batteries; lithium-lithium metal oxide batteries such as lithium manganese spinel batteries, and lithium-lithium cobalt oxide batteries, nickel cadmium batteries, nickel metal hydride batteries, nickel iron batteries, lead-acid batteries, nickel zinc batteries, silver zinc batteries, and Li-polymer batteries.

Batteries using electrode 110 as the cathode or anode or both may otherwise have the same architecture as with prior cathodes or anodes. The prior cathode or anode is simply replaced with electrode 110. Such batteries may have an increase in energy density of at least a factor of two or at least a factor of four as compared to the same battery without electrode 110. For instance, an electrode 110 with a lithium iron phosphate active material 60 used in place of a traditional lithium-ion battery cathode has been demonstrated to increase the energy density by a factor of two. In another example, an electrode 110 with graphite active material 110 used in place of a traditional lithium-ion battery anode has been demonstrated to increase the energy density by a factor of four.

Batteries using electrode 110 may also demonstrate improved capacity, capacity retention, efficiency and cycle lifetime as compared to identical batteries with a traditional cathode. For example, capacities per unit area (areal capacity) of 5-12 mAh/cm² have been demonstrated for a LiFePO₄-based cathode and capacities per unit area (areal capacity) of 8-12 mAh/cm² have been demonstrated for a graphite-based anode. The typical commercial electrode has a 2 mAh/cm² capacity. A LiFePO₄-based cathode cell using electrode 110 has been demonstrated to run 400 cycles at 1 C rate with no capacity fade.

Batteries using electrode 110 may be used to power any device. For instance, they may be used in consumer electronics, such as computers and phones, power tools, cars and other conveyances, and even in grid energy storage systems. Electrode 110 may be particularly well-suited for flexible batteries, batteries with sharp turns, and batteries with irregular geometries.

### Fuel Cells

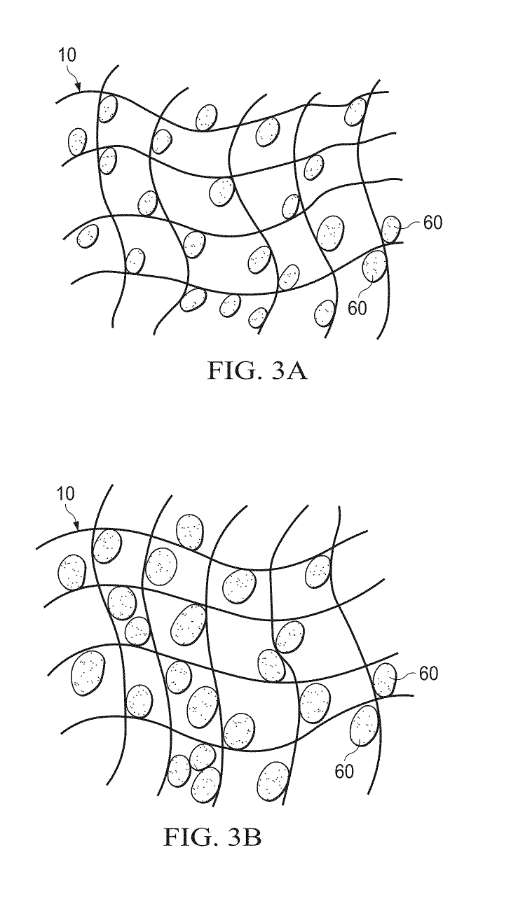

FIG. 5 is a schematic drawings of a fuel cell 200 using an electrode 110 as its anode. Fuel cell 200 further includes liquid electrolyte 210, solid electrolyte/separator 220, cathode 230, fuel chamber 240 through which fuel fluid flows as indicated by the arrows, exhaust chamber 250, through which exhaust fluid flows as indicated by the arrows, and electrical connectors 260.

The fuel cell in FIG. 5 is a simple design often used for hydrogen fuel cells. Other fuel cell designs, which may be more complex or simpler, are also compatible with electrode 110. Any suitable fuel, such as hydrogen gas or a hydrocarbon gas, is compatible with electrode 110. Reversible fuel cells are compatible with electrode 110, which may also be used as a cathode in such cells.

Fuel cells may further include monitoring and regulation components, including computers, as well as air flow control units. A fuel cell may include more than one individual cell.

Energy density and other properties dependent on the amount of energy a fuel cell can produce per unit fuel cell mass may be improved by using electrode 110. In addition, any properties that are decreased by electrode delamination in a fuel cell using a conventional electrode, such a fuel cell life, may be improved by using electrode 110.

Fuel cells of the present disclosure may be used in cars and other conveyances, portable electronics, and stationary energy-supply sources.

### Electrochemical Sensors

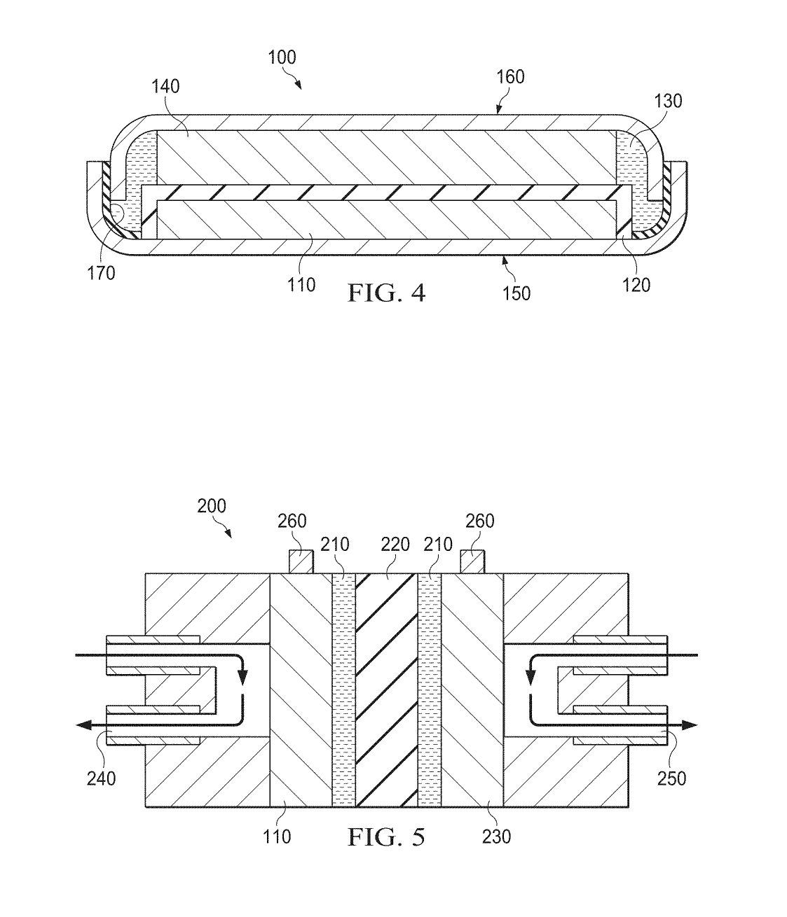

FIG. 6 is a simple electrochemical sensor 300 employing electrode 110 as a working electrode. The senor also contains counter electrode 310, reference electrode 320, leads 330, and sample container/protective housing 340. Electrochemical sensors using electrode 110 may be simpler than depicted; for instance they may lack a reference electrode, or they may be more complicated; for instance they may include displays, alarms, computers, and other elements.

Electrode 110 may be particularly useful in sensors that make repeated measurements over time.

Electrochemical sensors using electrode 110 may include any sensor in which an analyte or other material undergoes an electrochemical reaction with active material 60. For instance, the sensors may include medical sensors and environmental sensors, such as gas sensors.

### Ultracapacitors

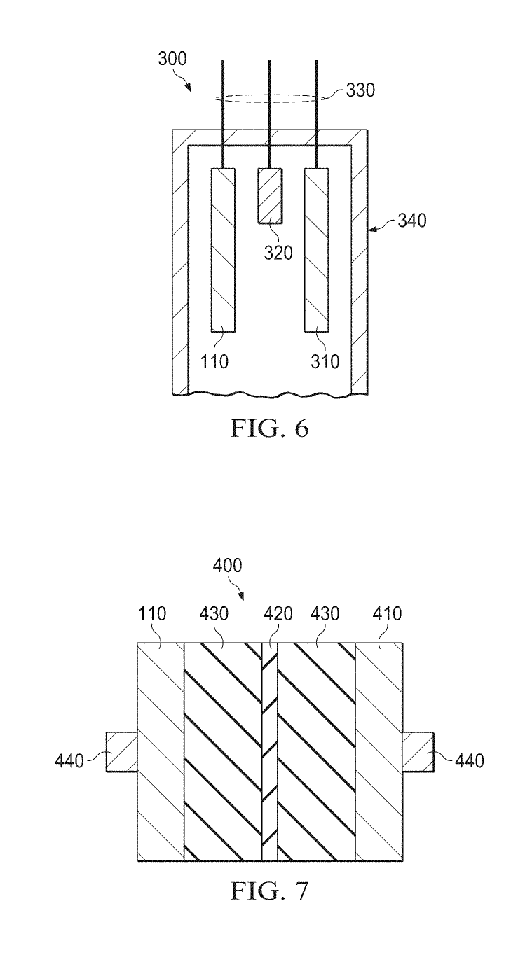

FIG. 7 is an ultracapacitor 400 employing reference electrode 110 as a first plate. Ultracapacitor 400 further includes second plate 410, separator 420, dielectric 430, and electrical connectors 440. Active material 60 undergoes an electrochemical reaction with dielectric 430 near first plate 110 to form a pseudocapacitance layer. Although only one plate is shown as using electrode 110 in FIG. 7, both plates may use electrode 110 and exhibit pseudocapacitance, particularly if the electrodes 110 have different active materials 60.

Ultracapacitors using electrode 110 may not experience problems with delamination, ion diffusivity, and electronic conductivity found in other ultracapacitors.

Ultracapacitors using electrode 110 may be used in any of a wide variety of applications, particularly applications where quick energy delivery is needed, such a power tools.

### EXAMPLES

The following examples illustrate aspects of the invention; no example is intended to encompass the invention as a whole. Furthermore, although some examples may present discrete embodiments of the invention, aspects of such examples may be combined with other variations of the invention as described above or in different examples unless such combinations would be clearly inoperable to one of skill in the art. For instance, the active material in a given example battery may be exchanged with a different active material.

### Example 1

### Electrode Formation

An aerogel containing reduced graphene oxide and thermally crosslinked poly(acrylic acid) (referred to as rGO-XPAA herein) was formed as described in Ha, et. al, “Mechanically stable thermally crosslinked poly(acrylic acid)/reduced graphene oxide aerogels,” ACS Appl. Mater. Interfaces 7(11):6220-9 (March, 2015).

In particular, graphene oxide (GO) was synthesized according to the Hummers's method with slight modification as described in Hummers, W. S., Jr.; Offeman, R. E, “Preparation of Graphitic Oxide,” J. Am. Chem. Soc. 80:1339-1339 (1958). In particular preoxidized graphite (5 g) was added to concentrated sulfuric acid (98%, 125 mL) in an ice bath. Potassium permanganate (15 g) was added slowly using a spatula with vigorous stirring of the solution. The mixture was stirred at 35° C. for 2 h. Then, deionized water (DI water, 230 mL) was carefully added using a pipet followed by terminating with DI water (700 mL) and 30% hydrogen peroxide solution (12.5 mL). Dilute hydrochloric acid solution with DI water in a volume ratio of 1:10 were used to remove residual manganese salt and excess acid products. Subsequently, the solution was washed with DI water until the pH of the rinsed water reached neutral. Finally, this solution was filtered using a vacuum assisted Büchner funnel and filtrate converted into a thick slurry of GO in water. The aqueous dispersion of GO was lyophilized under vacuum.

The GO to poly(acrylic acid) (PAA) ratio for all of the samples are represented as the relative weight percentage of PAAs to 100 parts of GOs. For example, 450 kDa/25 indicates PAA having a viscosity average molecular weight of 450 kDa was used in weight ratio of GO to PAA as 100:25. The corresponding amount of PAA was added to DI water (10 mL) using a 20 mL scintillation vial at room temperature for 12 h with vigorous stirring. After confirming complete dissolution of PAA in DI water, dried GO (50 mg) was added to the solution to make a 5 mg GO ml-1 concentrated solution. Additional stirring using a stir bar was performed for 2 h and then solution was sonicated using a 400 W probe sonicator with 10% amplitude for 10 min (24 kJ) in an ice bath. This process assisted in the complete exfoliation of GO in DI water and homogeneously mixed GO with PAA throughout the solution. After sonication, the solution was transferred to a 15 mL plastic vial with wide open neck using a glass pipet and freeze-dried by immersing into liquid nitrogen for 2 min then pulling vacuum at room temperature for 48 h. The resulting aerogels were low density dark brown spongelike materials with weak mechanical properties. If the GO was not completely exfoliated during the sonication step and/or if the aerogels were not completely dried during the vacuum step, the aerogels displayed significant shrinkage.

In an alternative method, not used for the materials of these examples, an aerogel may be synthesized by supercritical drying, such as using supercritical carbon dioxide fluids at high pressure, instead of freeze drying. In another alternative method, not used for the materials of these examples, a foaming agent may be used during formation of the aerogel. For instance, a reduced graphene oxide/polymer composite may be extruded with a foaming agent at high temperature to generate pores. Such extrusion methods may be particularly well-adapted to large-scale manufacturing.

After obtaining PAA/GO aerogels, all of the materials were taken out of the vial and immediately placed in a glass chamber containing HI vapor at room temperature for 24 h. Reducing the GO to rGO changed the color of the aerogels from dark brown to metallic black. To eliminate the residual HI vapor and simultaneously thermally cross-link PAAs to poly(acrylic anhydrides) (XPAAs), the aerogels were heated at 160° C. for 24 h in a vacuum oven. The resulting aerogel is shown in FIG. 1D.

A cathode was formed from a slurry of 80:5:15 (weight fraction) carbon coated LiFePO₄ sub-micron particles with a tap density of 1.0 g/cm³), Kraton® styrene-ethylene/butylene-styrene triblock copolymer (G1652) and Super-P conductive additive in toluene.

An anode was formed but with graphite particles having a tap density of 0.7 g/cm³, jet milled to micron-size and a tap density of 0.2 g/cm³ in toluene.

The cathode slurry or anode slurry was rapidly introduced into the aerogel by submerging the aerogel within the slurry agitated by magnetic mixing. After being removed from the slurry, the electrodes were dried, first at room temperature for several hours before drying under vacuum at 50° C. The cathode thus obtained is shown in FIG. 2G.

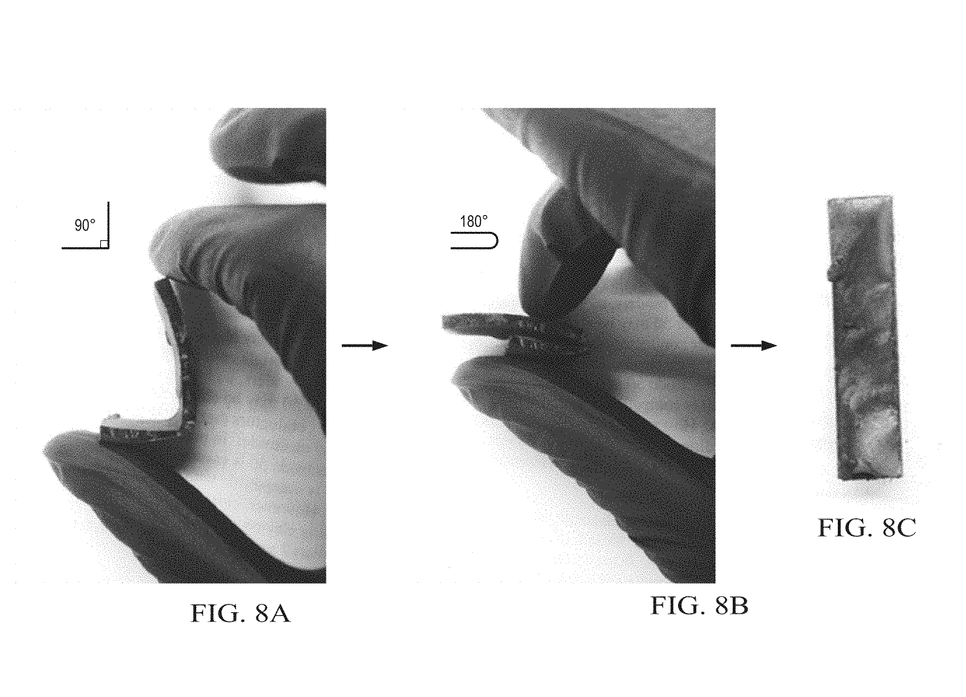

An aerogel formed as described in this Example 1 was bonded to a copper foil, then subjected to bending tests. As shown in FIGS. 8A-C, the material could be bent to 180 degrees without visible cracking, breaking, or fracturing.

### Example 2

### Cathode Testing

The cathode formed in Example 1 was assembled into a 2032 coin cells in an Argon filled glovebox (O2 and H2O less than 1 ppm). Lithium foil (Alfa) was used as the anode. The membrane separator was polyethylene (Celgard 2400) and the electrolyte was 1M LiPF6 in 1:1 (volume fraction) fluoroethylene carbonate (FEC) and diethylene carbonate. This electrolyte composition was selected because FEC is known to minimize dendritic growths occurring at high current densities upon lithium metal during electrodeposition (and accordingly this minimized the possibility that the lithium metal used as the counter and reference electrode would disrupt the experiment by inducing a short circuit or other failure) and was demonstrated to be superior to ethylene carbonate (EC) in this cell. The coin cell was tested with galvanostatic cycling in an Arbin battery tester between voltage boundaries defining completion of Li insertion/extraction: 2.5-4.0 V.

The carbon coated LiFePO₄ used in the cathode had a tap density of 0.93 g/cm³, limiting its theoretical particle loading (given a practically achievable capacity limit of 140 mAh/g measured at C/20 rate) to 9 mg/cm² and its areal capacity (given the same limit) to 1.3 mA h/cm² per 100 microns electrode film thickness. In the cathode formed and tested herein, carbon coated LiFePO₄ loading was as high as 7.5 mg/cm² under coin cell compression, providing 1.05 mA h/cm² areal capacity per 100 microns of film thickness. With carbon coated LiFePO₄ loadings of 30-32 mg/cm², the practical theoretical capacity for the cathodes studied here was 4.2-4.5 mAh/cm². The practical theoretical capacity of cathodes tested at C/10 rates is as high as 12 mA h/cm².

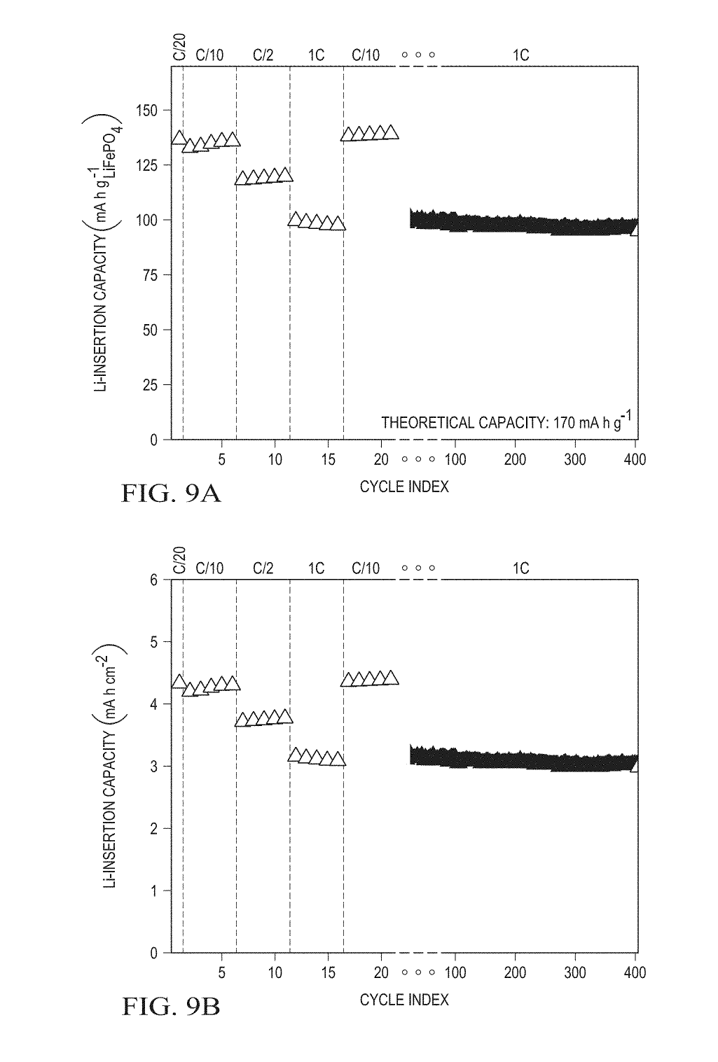

At C-rates of 0.1 C, 0.5 C and 1.0 C, the cathode cycled stably with specific capacities of 136, 119 and 95 mA h/g of carbon coated LiFePO₄. Factoring in the weight of the entire electrode—conductive additive, polymer binder and substrate—the specific capacities were adjusted to 109, 95 and 76 mAh/g. Capacity at different C rates for mass of active material is shown in FIG. 9A. Capacity at different C rates for electrode footprint is shown in FIG. 9B. The cathode further maintained a stable capacity after hundreds of cycles at 1 C.

### Example 3

### Cathode Testing with Active Particles Embedded in Aerogel

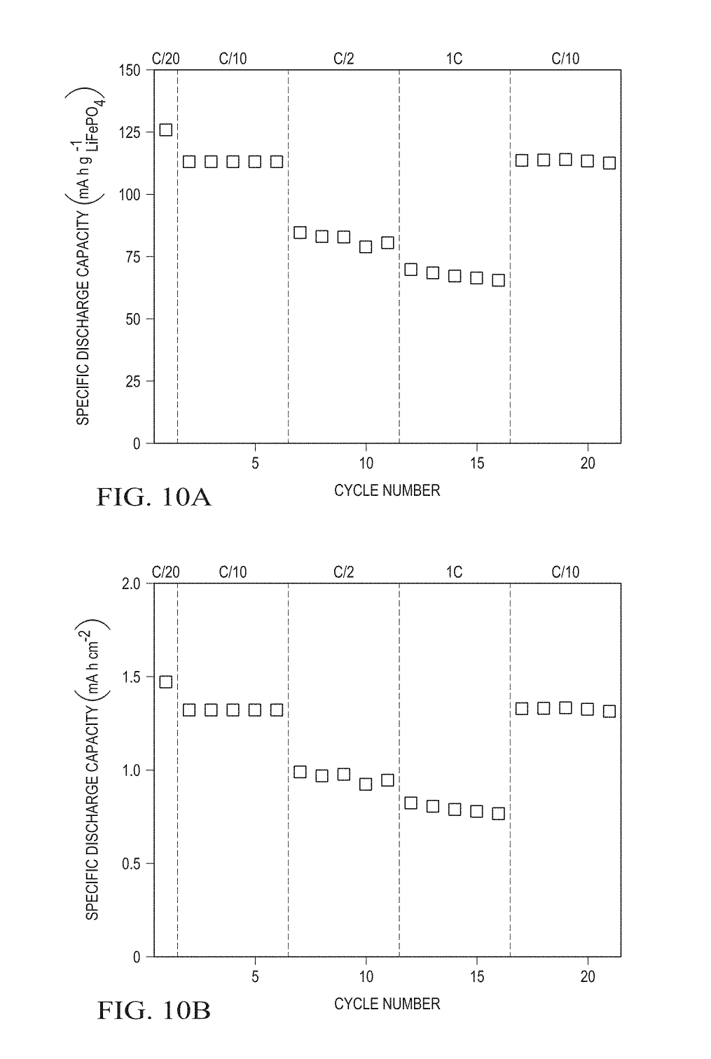

A cell was constructed as described above, but with the active material embedded within the aerogel as illustrated in FIG. 2H and also similar to FIG. 2B (but with a coated active material). The cell further contained a lithium metal counter electrode with a lithium foil reference electrode. The coin cell was tested with galvanostatic cycling in an Arbin battery tester between voltage boundaries defining completion of Li insertion/extraction: 2.5-4.0 V. With a carbon coated LiFePO₄ loading of 14 mg/cm², the practical theoretical capacity for the cathode was 2.0 mAh/cm². Capacity at different C rates for mass of active material is shown in FIG. 10A Capacity at different C rates for electrode footprint is shown in FIG. 10B.

### Example 4

### Anode Testing

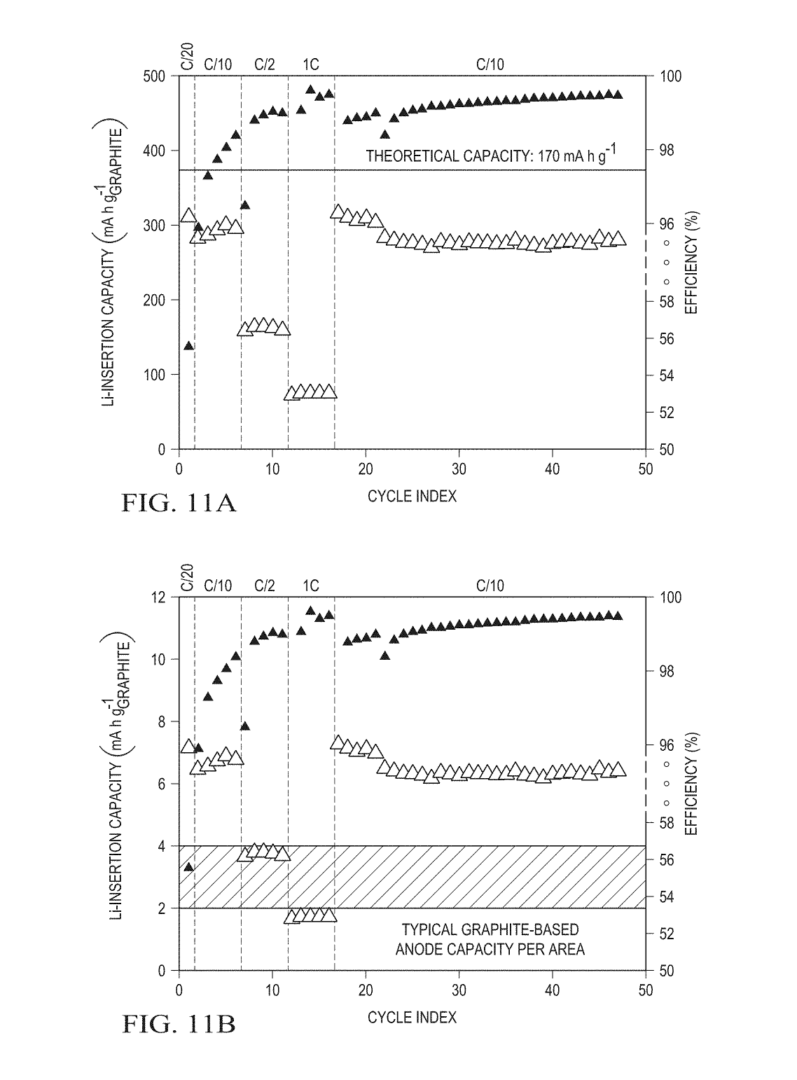

A cell was constructed as described above, but with the anode formed in Example 1 and a lithium metal counter and reference electrode. The coin cell was tested with galvanostatic cycling in an Arbin battery tester between voltage boundaries defining completion of Li insertion/extraction: 0.01-1.0 V. Capacity at different C rates for mass of active material is shown in FIG. 11A. Capacity at different C rates for electrode footprint is shown in FIG. 11B. The per area capacity of the anode was stable at near 8 mAh/cm²at C/10 rate. Current commercial anodes charge to about 2 mAh/cm².

### Example 5

### Coating Testing

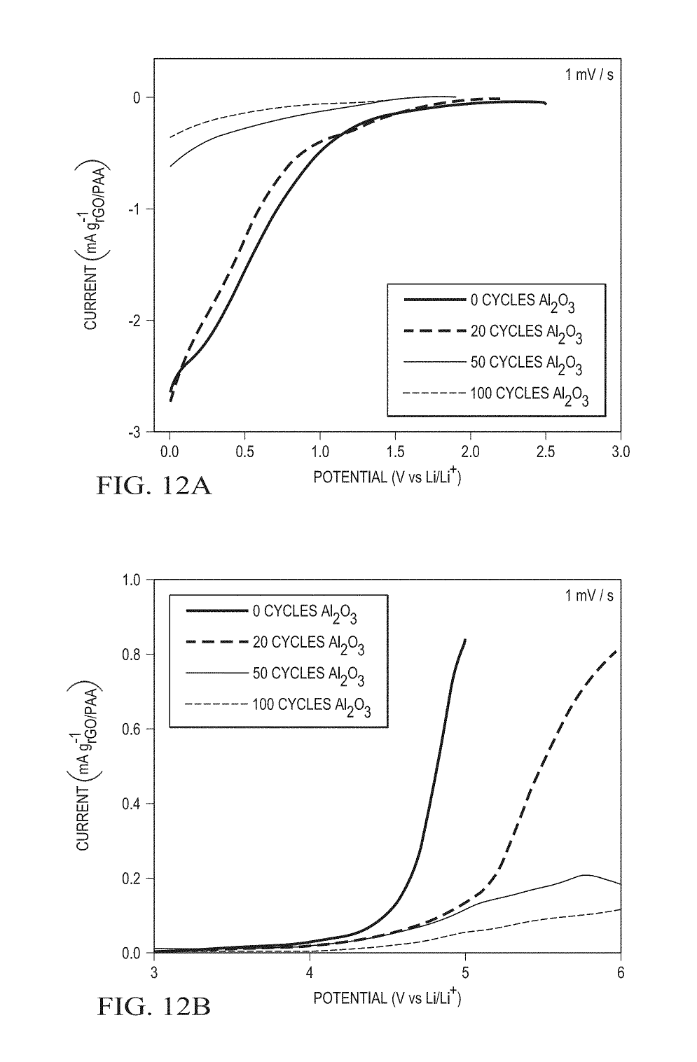

FIG. 12A shows that a thin coating of Al₂O₃ protects a reduced graphene oxide-polymer aerogel from decomposition of the electrolyte by formation of a solid electrolyte interphase (SEI), when subjected to linear voltammetry at 1 mV/s from an open circuit potential to a potential of 0 V vs/Li/Li⁺ using a 1 M LiPF₆ in 1:1 volume ration FEC:DEC electrolyte. FIG. 112 shows that a thin coating of Al₂O₃ protects a reduced graphene oxide-polymer aerogel from decomposition of the electrolyte when subjected to linear voltammetry at 1 mV/s from an open circuit potential to a potential of 6 V vs Li/Li⁺ using a 1 M LiPF₆ in 1:1 volume ration FEC:DEC electrolyte. The cycles of Al₂O₃ correspond to thickness of the coating applied in one monolayer per cycle.

Although the present disclosure and its advantages have been described in detail, it should be understood that various changes, substitutions and alternations can be made without departing from the spirit and scope of the disclosure.

1. An electrode comprising:
an electrically conductive, porous aerogel having pores and comprising:
an electrically conductive graphene oxide having functional groups; and
a polymer covalently bonded, physically bonded, or both to the graphene oxide; and
an active material covalently bonded, physically bonded, or both to the porous aerogel within the pores.

2. The electrode of claim 1, wherein the polymer is crosslinked.

3. The electrode of claim 1, wherein the electrically conductive graphene oxide comprises reduced graphene oxide.

4. The electrode of claim 1, wherein the bonded active material is bonded to at least a portion of the functional groups.

5. The electrode of claim 1, wherein the bonded active material is bonded to the polymer.

6. The electrode of claim 1, wherein the polymer comprises poly(acrylic acid).

7. The electrode of claim 1, wherein the active material comprises lithium iron phosphate.

8. The electrode of claim 1, wherein the active material comprises graphite.

9. The electrode of claim 1, wherein the electrode has a porosity of at least 5%.

10. The electrode of claim 1, wherein the active material participates in an electrochemical reaction.

11. The electrode of claim 1, wherein the active material catalyzes an electrochemical reaction.

12. A method of forming an electrode, the method comprising:
covalently bonding, physically bonding, or both a polymer to an electrically-conductive graphene oxide;
forming an aerogel;
covalently bonding, physically bonding, or both an active material to the aerogel.

13. The method of claim 12, further comprising introducing a slurry containing active material into the aerogel prior to its bonding to the aerogel.

14. The method of claim 12, wherein at least two of the three steps occur simultaneously.

15. The method of claim 12, wherein bonding the active material to the aerogel occurs during use of the aerogel in an electrochemical device.

16. A battery comprising at least one electrode comprising:
an electrically conductive, porous aerogel having pores and comprising:
an electrically conductive graphene oxide having functional groups; and
a polymer covalently bonded, physically bonded, or both to the graphene oxide; and
an active material covalently bonded, physically bonded, or both to the porous aerogel within the pores.

17. The battery of claim 16, wherein the battery has per area capacity of its electrodes of at least 2 mAh/cm².

18. The battery of claim 16, wherein the battery is rechargeable and retains at least 85% of its capacity after the first charge/discharge cycle for at least 500 additional cycles.

19. (canceled)

20. (canceled)

21. (canceled)
